(19) United States
(12) Patent Application Publication
(10) Pub. No.: US 2022/0207871 A1
(43) Pub. Date: Jun. 30, 2022

(54) Digital License Tag

(71) Applicant: Global Unmanned Products LLC, Dundee, OR (US)

(72) Inventors: Jeffrey Gray Ratcliffe, Dundee, OR (US); Solomon Singer, Lowell, OR (US); Jay Abramovitz, Dundee, OR (US)

(73) Assignee: Global Unmanned Products LLC, Dundee, OR (US)

(21) Appl. No.: 17/644,812

(22) Filed: Dec. 17, 2021

Related U.S. Application Data
(60) Provisional application No. 63/199,425, filed on Dec. 27, 2020.

(51) Int. Cl. G06V 20/17; B64C 39/02; H04W 4/80

(52) U.S. Cl. CPC G06V 20/17; B64C 39/024; B64C 2201/122; B64C 2201/127; H04W 4/80

(57) ABSTRACT

The Digital License Tag is an electronic device for providing a digital identity and geospatial telemetry broadcast data for an unmanned vehicle comprising a local memory identity storage, a cellular transmission device, a wireless network transmission device, a Bluetooth transmission device, a global position telemetry device, a light emitting device having a beacon enabling visual recognition of said unmanned vehicle, and a power source enabling a unique digital identity and the acquisition and broadcast of a current position telemetry and identity dataset bread crumb for said unmanned vehicle and a computer software based system having a datastore to verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle. It is block chain capable.

### TECHNICAL FIELD OF THE INVENTION

This invention relates generally to a Digital License Tag device in the form of an electronic device configured to enable an unmanned vehicle to be identified with an unique digital identity (digital license plate/tag), or an electronic license plate/tag, wherein said digital license tag has confirmable/verifiable, and/or registered/recorded digital identities for unmanned vehicles, combined with the associated verified owner/operator data/records/information. This invention relates more specifically to a Digital License Tag device in the form of an electronic device configured as a digital license plate/tag enabled to provide/broadcast/transmit its identity and its present position telemetry data.

This invention relates generally to a Digital License Tag device system in the form of a wireless tracking system for unmanned vehicles wherein each unmanned vehicle is equipped with its own electronic identity and telemetry device enabling a digital license plate/tag device that connects to a networked system enabling the collecting, transmitting, and storing of verified location bread crumbs (digital identity, registration, present telemetry data/information, global position, geographic and geospatial location data/information) of an unmanned vehicle.

This invention relates generally to a Digital License Tag device system in the form of a wireless tracking system for unmanned vehicles enabled to store/verify/authenticate confirmable/verifiable, and/or registered/recorded digital records of an unmanned vehicle's telemetry, owner, operator, time of operations, geospatial position, global position, and path of movement/travel. This invention relates more specifically to a Digital License Tag device system in the form of a wireless tracking system for unmanned vehicles enabled to store/verify/authenticate confirmable/verifiable, and/or registered/recorded digital records of an unmanned vehicle's telemetry, owner, operator, time of operations, geospatial position, and path of movement/travel wherein the stored data enables block chaining of verifiable data blocks.

### BACKGROUND

There is a need today for the capability to track the whereabouts of unmanned vehicles operating in the air, on the land, and on/in the water. There is a need for a digital license plate comprising at least confirmable/verifiable, and/or registered/recorded digital identity for an unmanned vehicle (drone, robot, wheeled vehicle) associated with verified owner/operator information attached.

There exist today several technologies that might be enabled to provide for a digital license plate for unmanned vehicles such as drones, and robotic cars. There are wireless radio transponder and telemetry technologies available for tracking airplanes and trucks which could be enabled to provide for a digital license plate. There are also numerous cellular and satellite communications and telemetry technologies available to implement a transponder type system to enable digital license plates.

However, there is not present in the prior art an electronic telemetry device that combines local memory storage, cellular transmission, wireless network transmission, bluetooth transmission, and global position telemetry that is connected to a data source to verify a unique identity for said device. There is not present in the prior art a wireless tracking system for unmanned vehicles enabled to store/verify/authenticate confirmable/verifiable, and/or registered/recorded digital records of an unmanned vehicle's identity, telemetry, owner, operator, time of operations, geospatial position, and path of movement/travel wherein the stored data enables block chaining of verifiable data blocks.

As a result of differing electronics communications speeds and technologies there are various wireless communications technologies available but none combine a unique digital identity with Global Positioning System, Cellular, WiFi, Bluetooth, and Light Beacon technologies synchronized together to create a complete coherent bread crumb trail of the path followed by an unmanned vehicle wherein such an electronic device ought be installed. What is not present in the prior art is an electronic device that combines unique registration capable digital identity, local memory storage, cellular transmission, wireless network transmission, bluetooth, and global position telemetry so as to enable the creation of a complete bread crumb to indicate the identity and current position telemetry of the electronic device with sensors for received cellular signal strength, temperature, light strength (day or night indicator), flip sensor (crash detector), and air pressure (pressure altitude) along with air quality index.

In light of the foregoing prior art, there is a need for a Digital License Tag electronic device that combines local memory identity/registration storage, cellular transmission, wireless network transmission, bluetooth transmission, and global position telemetry that is connected to a data source to verify a unique identity for said device, and an associated computer software based system to enable a wireless tracking system for unmanned vehicles enabled to store/verify/authenticate confirmable/verifiable, and/or registered/recorded digital records of an unmanned vehicle's identity, telemetry, owner, operator, time of operations, geospatial position, and path of movement/travel wherein the stored data enables block chaining of verifiable data blocks. Further, there is a need for a Digital License Tag electronic device with sensors for received cellular signal strength, temperature, light strength (day or night indicator), flip sensor (crash detector), and air pressure (pressure altitude) along with air quality index.

In short, what is needed is an electronic device with the built-in data security architecture, multifunctional approach, and all-in-one design needed to embody a Digital License Tag.

### BRIEF SUMMARY OF THE INVENTION

According to a first aspect of the invention, there is a Digital License Tag electronic apparatus for providing a digital identity and geospatial telemetry broadcast data for an unmanned vehicle comprising a local memory identity storage, a cellular transmission device, a wireless network transmission device, a bluetooth transmission device, a global position telemetry device, and a power source enabling storage of a unique digital identity and the broadcast of said unique digital identity and a current position geospatial telemetry and identity dataset bread crumb for said unmanned vehicle.

According to a second aspect of the invention, there is a Digital License Tag electronic apparatus further comprising a light emitting device having a beacon enabling visual recognition of said unmanned vehicle.

According to a third aspect of the invention, there is a Digital License Tag electronic apparatus further comprising a set of sensors comprising not less than, a received cellular signal strength sensor, a temperature sensor, a light strength (day or night indicator) sensor, a flip sensor (crash detector), an air pressure (pressure altitude) sensor and air quality index.

According to a fourth aspect of the invention, there is a Digital License Tag electronic apparatus further comprising internet enabled software application enabled to store said current position telemetry and identity dataset bread crumb for said unmanned vehicle when broadcasted by said electronic device in a datastore.

According to a fifth aspect of the invention, there is a Digital License Tag electronic apparatus, further comprising internet enabled software application enabled to store and authenticate said current position telemetry and identity dataset bread crumb for said unmanned vehicle when broadcasted by said electronic device in a datastore.

According to a sixth aspect of the invention, there is a Digital License Tag electronic apparatus further comprising internet enabled software application enabled to store and transmit said current position telemetry and identity dataset bread crumb for said unmanned vehicle when broadcasted by said electronic device in a datastore.

According to a seventh aspect of the invention, there is a Digital License Tag electronic apparatus, further comprising internet enabled software application enabled to store, authenticate, and transmit said current position telemetry and identity dataset bread crumb for said unmanned vehicle when broadcasted by said electronic device in a datastore.

According to an eighth aspect of the invention, there is a Digital License Tag electronic apparatus, further comprising internet enabled software application enabled to store, authenticate, and transmit said current position telemetry and identity dataset bread crumb for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle.

According to a ninth aspect of the invention, there is a Digital License Tag electronic apparatus, further comprising internet enabled software application enabled to store, authenticate, and transmit said current position telemetry and identity dataset bread crumbs for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

According to a tenth aspect of the invention, there is a Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, and a power source enabling a unique digital identity and the acquisition and broadcast of a current position telemetry and identity dataset bread crumb for said unmanned vehicle and an internet enabled computer software application based system having a datastore to store and verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle.

According to an eleventh aspect of the invention, there is a Digital License Tag electronic device as in the tenth aspect, further comprising a set of sensors comprising not less than, a received cellular signal strength sensor, a temperature sensor, a light strength (day or night indicator) sensor, a flip sensor (crash detector), an air pressure (pressure altitude) sensor and air quality index sensor. There is optionally a crash sensing function wherein the system goes into a cellular and WiFi ping mode to broadcast/re-broadcast a radio signal by which the device/drone can be recovered.

According to a twelfth aspect of the invention, there is a Digital License Tag electronic device as in the tenth aspect, wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle.

According to a thirteenth aspect of the invention, there is a Digital License Tag electronic device as in the tenth aspect, wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

According to a fourteenth aspect of the invention, there is a Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, a light emitting device having a beacon enabling visual recognition of said unmanned vehicle, and a power source enabling a unique digital identity and the acquisition and broadcast of a current position telemetry and identity dataset bread crumb for said unmanned vehicle and a computer software based system having a datastore to verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle.

According to a fifteenth aspect of the invention, there is a Digital License Tag electronic device as in the fourteenth aspect, further comprising a set of sensors comprising not less than, a received cellular signal strength sensor, a temperature sensor, a light strength (day or night indicator) sensor, a flip sensor (crash detector), an air pressure (pressure altitude) sensor and air quality index.

According to a sixteenth aspect of the invention, there is a Digital License Tag electronic device as in the fourteenth aspect, wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle.

According to a seventeenth aspect of the invention, there is a Digital License Tag electronic device as in the fourteenth aspect, wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

An advantage of the Digital License Tag electronic device is the enabling of geospatial telemetry and digital identity data to be digitally stored in an unmanned vehicle. Unmanned vehicles include, but are not limited to, unmanned vehicles operating in the air, on the land, and on/in the water. Further the present invention enables an unmanned vehicle to broadcast its geospatial telemetry and digital identity data. The geospatial telemetry and digital identity data is configurable into bread crumbs containing, but not limited to, the digital identity, registration, present telemetry data/information, global position, geographic and geospatial location data/information for the current position of the unmanned vehicle.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

The embodiments for a remote identification tracker device for attachment to an unmanned aircraft are herein described. The device is designed to be attached to any unmanned aircraft (UA), making it compatible with upcoming FAA regulations describing the need for tracking of UA (FAA proposed ruling). This device allows easy retrofitting and compliance for current aircraft that currently do not have trackers or any remote identification (ID) broadcast. This device is being developed in accordance with ASTM F3411-19 Remote ID for Unmanned Aircraft Standard, as well as the FAA Remote ID initial ruling for Unmanned Aircraft. It is noted that the FAA principles here can be equally applied to and made useful for land and water based transportation systems.

The device being developed has unique features which set it apart from any other LTE (cellular-connected) tracker available, or any other remote ID device that has been designed: The Remote ID device has a secure cellular signal connected to a blockchain or similar high-security, immutable database online from which the flight data and ID information for the flight is stored and retrieved. The device has a suite of environmental sensors which include light sensors, humidity, temperature, barometric pressure, orientation (roll, pitch and yaw), air quality sensor, and potentially others. The device has an in-built, high-brightness multicolor and multi-function LED safety strobe, which is used to increase the aircraft safety and visibility during flight, as well as notify the user of certain device states.

[symbol]

The all-in-one embodiment of this device allows it to function as a small cloud-connected weather station on the UA, a remote ID location and identification tracker, and a safety strobe beacon.

Additional features will include the ability to broadcast a WiFi signal when not in connection to the cloud server over the internet, such as in cellular-denied environments. This is in compliance with ASTM F3411-19, Standard for Remote ID of Unmanned Aircraft. In this case, a broadcast of an encrypted WiFi signal is initiated when cellular connection is lost. This allows officials and officers of the law to see information about the UA, including the owner, operator location, and current location of the UA during flight, even without internet connection or cellular connectivity. This information will be decrypted by an approved application running on an authenticated smart device, which ensures the data security and privacy of the UA operator.

Another unique feature set is the ability for the WiFi connected application to have a backchannel connection to the aircraft and operator. By having a connection back to the pilot in command via the application and WiFi/cellular link, the operator can be given official legal notice to ‘cease and desist’ or ‘land immediately’ or another command from the official. Here, the notification and alert system is activated on the operator's smart device, which can either be connected to the Remote ID device via WiFi, long range bluetooth (e.g. BLE5), or cellular connectivity to the same online server to which the device is connected. A notification system is beneficial to ensure the compliance of the operator of the UA, and allows communication between regulatory officials and the UA operator at any time.

The multifunction LED strobe on the device can act as both a unit self-check indicator (e.g. by blinking green, or with multiple blinks of a white light when ready to fly), as well as a battery or signal level indicator during flight. In addition, the regulatory official may be able to control the color of the light via backchannel connection to the Remote ID device. For example, to pick a drone or a blink rate for UA out of a large area, the official can simply change the strobe color, and notify the operator of the required action. Finally, the strobe can act as a safety device which can automatically come on at dusk (by using the light sensor onboard the device), or can be programmed to be on at all times for safety and visibility of the UA. By having an all-in-one and self-contained unit, it improves the accessible feature set and increases the compliance with the FAA Remote ID rule due to ease of use and operator benefit.

Applications of this device are many, which can range from firefighting operations, Unmanned Traffic Management (UTM), compliance with the upcoming FAA Remote ID ruling, asset or valuable delivery tracking, UA fleet management and tracking for insurance or liability purposes, Beyond Visual Line-Of-Sight (BVLOS) UA flights where tracking and near-real time position reporting is required, Search and Rescue UA operations, crash/incident analysis by proper authorities, enhancing Visual Line-Of-Sight (VLOS) range for the operator, enabling easy detection for collision avoidance with other vehicles/drone, and a variety of other uses in the aviation field. Note: Device could also be used by unmanned ground or water robotic vehicles.

These features are included and performed by the following components of the device:

The battery allows the unit to be self-contained, and self-reliant for power.

The USB charger and data connection is for allowing serial communication to the microprocessor on the device while charging the battery.

There is a 6-axis electronic gyroscope for inertial measurements and position information of the aircraft, and also includes a sensitive barometric pressure sensor for pressure altitude reporting (as required by the FAA proposed Remote ID rule). This data is sent to the microprocessor.

The microprocessor is an onboard computer which manages data from peripheral sensors, communicates with the cellular and GPS radios, and manages decisions such as whether to switch to WiFi/BLE5 broadcast when cellular signal is lost, or whether to change the LED color or flashing pattern to alert the operator of a state change. The microprocessor also has a long range bluetooth radio and a WiFi radio with associated inverted-F antennas (compact internal antennas) on the board. The microprocessor also manages the connection to the LED strobe.

A multi-modal communications module that has a GPS receiver and a cellular radio built-in together was chosen. In an embodiment, the multi-modal communications module comprises an FCC-certified Global Navigation Satellite System (GNSS) receiver and CAT M1-LTE and NB-IoT radio system built into one. It is capable of sending GPS position solutions over LTE at speeds up to 5-10 Hz (5 to 10 times per second) due to the separate and independent radio systems within the module. The initial FAA Remote ID ruling specifies 1 Hz or better GPS position update rate must be provided for the remote ID of UA. The fast update rate of this module and the resulting live GPS location fixes from this Remote ID device will stand out as a quality tracker due to the fast speeds, since many trackers available have significantly lower speeds of GPS location update rates.

GNSS stands for Global Navigation Satellite System, another term for the global constellation of navigation satellites that transmit from space certain positioning and timing data to GNSS receivers for calculating precise 3D location fixes.

CAT M1-LTE is an acronym for Category M1, a low-power, wide area network (LPWAN) cellular communication protocol which is commonly used for Internet of Things (IoT) such as smart devices, wearables, connected smart homes, and car cellular connectivity. It has spectrum allocation in licensed cellular bands, is protected from interference, and has enhanced security and privacy compared to unlicensed spectrum allocations. LTE is an abbreviation for Long Term Evolution, another term for 4G, a standard high-bandwidth, large data-throughput cellular technology which many cellular phones and smart devices use. Both CAT M1 and LTE use the licensed cellular bands, which are sections of the cellular frequency allocation, and are termed bands 1, 3, 4, 5, 12, 13, 14, 18, etc. All other wireless communications technologies and their evolutions are suitable WiFi options for the apparatus of the present invention.

NB-IoT stands for Narrow-Band Internet of Things, a Low-Power Wide Area Network (LPWAN) communication protocol which is used over cellular signal to provide narrow bandwidth, low-latency and low-data-use communications to small devices that need internet connection through cellular signal (such as our Remote ID device). This protocol is implemented by the cellular radio over existing channels. NB-IoT allows low power consumption, cellular system capacity, spectrum allocation efficiency, and long range communication.

Other embodiments can include a device with ports for external antennas, external LED strobe, and a robust case instead of the internal antennas shown here. This can be used for when the device is installed inside an UA, and for when the antennas and strobe need to be routed to the outside of the aircraft.

Another embodiment can be where the device pulls power from the UA power system instead of having its own battery, which can be used for aircraft where the device is permanently installed in an inaccessible or challenging location within the hull or wing of the aircraft, and it would benefit from being powered through the supply bus of the UA.

What makes this device unique is the built-in data security architecture, multifunctional approach, and all-in-one design. What makes this device unique is a closer/tighter/more complete integration and inclusion of this invention into the host vehicle/robot/drone enabling an incorporation into an unmanned vehicle that was post consumer purchased or into the manufacture of unmanned vehicles.

The preferred embodiment of the apparatus of the present invention is configured for aerial flying drones. Obvious other embodiments for all types and kinds of unmanned vehicles, robots, automated moving equipment, and chattel are within the scope of the present invention.

Making the apparatus of the present invention starts with an electronic device comprised of a telemetry platform having a cellular communications chipset, a global positioning system (GPS) chip set, an array of sensors comprising not less than, a received cellular signal strength sensor, a temperature sensor, a light strength (day or night indicator) sensor, a flip sensor (crash detector), an air pressure (pressure altitude) sensor and air quality index sensor, a memory storage chip set, a bluetooth communications chip set, and an LED all arranged together in an electronic device and all connectively attached in communication with each other and controlled customizable software to enable providing a digital identity and geospatial telemetry broadcast data for an unmanned vehicle wherein this electronic device is installed, and attached to.

The frequency of data captures, and updates for the sensors, is adjusted to capture and store current time and geospatial telemetry data of the current position of an unmanned vehicle, or chattel, to enable live updates. Live updates means that the frequency of data captures and storage events of said data capture happens often enough to cover sufficient bread crumb creation so as to enable viewing of a trail of bread crumbs appropriate to the resolution of the map upon which the bread crumbs is displayed as two (x and y axis), three (x, y, and z axis), or four (x, y, z, and time) dimensional location data points. For example, in an embodiment of the present invention, live updates for the GPS is sufficient for an aerial drone when the frequency of its updates is configured to 1 Hz. A computer circuit chip with separate cellular and GPS radio frequency circuitry and antennas makes this possible on a single integrated circuit.

The sensor chip sets are selected with a 1 Pa sensitivity to altitude measurement to within 8 cm, as well as 6 axis accelerometer to refine the GPS coordinates to cm accuracy. A more powerful RGB LED is added to serve as a beacon both for visibility at night, but also as a means of Visible Light Communication (VLC). The use of wireless network communications and bluetooth technologies in the present invention has several uses. One use is that it is necessary to broadcast the identity when cellular service is not available. A second use is that the combination enables wireless neighborhood area networking. A third use is as a back channel (alternate communication channel not in the primary communication path) that could use wireless networking or bluetooth technologies to communicate outside of the cellular channel.

In an embodiment of the invention, there is a Digital License Tag electronic apparatus for providing a digital identity and geospatial telemetry broadcast data for an unmanned vehicle comprising a local memory identity storage, a cellular transmission device, a wireless network transmission device, a bluetooth transmission device, a global position telemetry device, and a power source enabling storage of a unique digital identity and the broadcast of said unique digital identity and a current position geospatial telemetry and identity dataset bread crumb for said unmanned vehicle. It is noted that Bluetooth may also be used to configure the device/apparatus of the present invention and its incorporation into an unmanned vehicle.

In an embodiment of the invention, there is a Digital License Tag electronic apparatus further comprising a light emitting device having a beacon enabling visual recognition of said unmanned vehicle.

In a preferred embodiment of the invention, there is a Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, and a power source enabling a unique digital identity and the acquisition and broadcast of a current position telemetry and identity dataset bread crumb for said unmanned vehicle and an internet enabled computer software application based system having a datastore to store and verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle. Unmanned vehicles include, but are not limited too, unmanned vehicles operating in the air, on the land, and on/in the water.

In an embodiment of the invention, there is a Digital License Tag electronic apparatus further comprising a set of sensors comprising not less than, a received cellular signal strength sensor, a temperature sensor, a light strength (day or night indicator) sensor, a flip sensor (crash detector), an air pressure (pressure altitude) sensor and air quality index sensor.

In an embodiment of the invention, there is a Digital License Tag electronic apparatus further comprising internet enabled software application enabled to store said current position telemetry and identity dataset bread crumb for said unmanned vehicle when broadcasted by said electronic device in a datastore.

In an embodiment of the invention, there is a Digital License Tag electronic apparatus, further comprising internet enabled software application enabled to store and authenticate said current position telemetry and identity dataset bread crumb for said unmanned vehicle when broadcasted by said electronic device in a datastore.

In an embodiment of the invention, there is a Digital License Tag electronic apparatus further comprising internet enabled software application enabled to store and transmit said current position telemetry and identity dataset bread crumb for said unmanned vehicle when broadcasted by said electronic device in a datastore.

In an embodiment of the invention, there is a Digital License Tag electronic apparatus, further comprising internet enabled software application enabled to store, authenticate, and transmit said current position telemetry and identity dataset bread crumb for said unmanned vehicle when broadcasted by said electronic device in a datastore.

In an embodiment of the invention, there is a Digital License Tag electronic apparatus, further comprising internet enabled software application enabled to store, authenticate, and transmit said current position telemetry and identity dataset bread crumb for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle.

In an embodiment of the invention, there is a Digital License Tag electronic apparatus, further comprising internet enabled software application enabled to store, authenticate, and transmit said current position telemetry and identity dataset bread crumbs for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

In a preferred embodiment of the invention, there is a Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, a light emitting device having a beacon enabling visual recognition of said unmanned vehicle, and a power source enabling a unique digital identity and the acquisition and broadcast of a current position telemetry and identity dataset bread crumb for said unmanned vehicle and a computer software based system having a datastore to verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle.

In a preferred embodiment of the invention, there is a Digital License Tag electronic device further comprising a set of sensors comprising not less than, a received cellular signal strength sensor, a temperature sensor, a light strength (day or night indicator) sensor, a flip sensor (crash detector), an air pressure (pressure altitude) sensor and air quality index sensor.

In a preferred embodiment of the invention, there is a Digital License Tag electronic device wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle.

In a preferred embodiment of the invention, there is a Digital License Tag electronic device wherein the internet enabled software application further enables a creation and an electronic storage of a data block in the datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

An advantage of the electronic device is the enabling of geospatial telemetry and digital identity data to be digitally stored in an unmanned vehicle. Further the present invention enables an unmanned vehicle to broadcast its geospatial telemetry and digital identity data. The geospatial telemetry and digital identity data is configurable into bread crumbs containing, but not limited to the digital identity, registration, present telemetry data/information, global position, geographic and geospatial location data/information for the current position of the unmanned vehicle.

In an embodiment of the invention, there is a Digital License Tag device in the form of an electronic device configured to enable an unmanned vehicle to be identified with an unique digital identity. Said digital identity (digital license plate/tag, or an electronic license plate/tag) is registered and unique to the unmanned vehicle wherein it is installed, integrated, and/or connectively attached. Further, said digital license tag has confirmable/verifiable, and/or registered/recorded digital identities for unmanned vehicles, combined with the associated verified owner/operator data/records/information, and is configured as a digital license plate/tag enabled to provide/broadcast/transmit its identity and its present position telemetry data.

In an embodiment of the invention, there is a Digital License Tag device system in the form of a wireless tracking system for unmanned vehicles wherein each unmanned vehicle is equipped with its own electronic identity and telemetry device enabling a digital license plate/tag device that connects to a networked system enabling the collecting, transmitting, and storing of verified location bread crumbs (digital identity, registration, present telemetry data/information, global position, geographic and geospatial location data/information) of an unmanned vehicle.

In an embodiment of the invention, there is a Digital License Tag system in the form of a wireless tracking system for unmanned vehicles enabled to store/verify/authenticate confirmable/verifiable, and/or registered/recorded digital records of an unmanned vehicle's telemetry, owner, operator, time of operations, geospatial position, global position, and path of movement/travel.

In an embodiment of the invention, there is a Digital License Tag system in the form of a wireless tracking system for unmanned vehicle's enabled to store/verify/authenticate confirmable/verifiable, and/or registered/recorded digital records of an unmanned vehicles telemetry, owner, operator, time of operations, geospatial position, and path of movement/travel wherein the stored data enables block chaining of verifiable data blocks. The data, stored in blocks, is stored electronically in datastores comprising database software and electronic data storage devices to include, but not be limited to solid state memory devices and computer hard-drives.

The apparatus of the present invention is a compact and self-contained drone tracker system. This apparatus is a secure, internet-connected tracking device that is completely self-contained. It sends unique identifier information, GPS location, and environmental data (such as pressure altitude) to a secure online platform. An authorized user can log in anytime and see current and past data from any aircraft equipped with this device.

The apparatus of the present invention is used to track the movements of a thermal imaging drone that is flown into a fire zone to scout fire progress and provide valuable realtime geospatial location data to provide and/or enhance the accuracy of the location of the thermal image data captured.

The electronic device of the present invention can be mounted with adhesive, hook and loop attachment, a custom mounting plate, or a zip-tie. In a preferred embodiment, the device to be added to a drone only weighs 65 grams (with the velcro), so it is extremely light. In an embodiment, the power source is a battery that can last for a long time maintaining operation of the electronic device for over a day of full use. Mounts can be made for virtually any drone. Omnidirectional antennas are used to enable placement of the electronic device in any orientation on or in the drone.

In a preferred embodiment, the online database of the present invention has a live map, updated every 3-5 minutes with GPS data from the tracker device over long-range cellular signal, and a link monitor and terminal shows current connection status, environmental data, and allows direct communication with the device from the terminal.

Uses for the apparatus of the present invention include but are not limited to the ability to do the following: Track drones in the airspace from anywhere. Maintain secure logs of flights made by the drone any time. Show the data of any aircraft in near real time, including commercial drone flights. Enhance situational awareness of drones to manned aircraft. Improve safety on Beyond Visual Line of Sight drone flights. Track government-operated or commercial drones for security and safety. Securely collect and manage sensitive data on operators and drone telemetry.

Embodiments of the present invention include, but are not limited to do the following: Highest security rugged industrial-grade LTE and GPS radio system. High security custom online database for drone location data storage. True live GPS update speeds up to 1 Hz (a new GPS fix every second). Ruggedized high-gain internal antennas for even longer range. User-configurable high-intensity built-in anti-collision strobe light. Weatherproof enclosure.

Alternate embodiments include but are not limited to the ability to broadcast location and identifier data even when outside of cellular signal range. A mobile application is enabled to receive the data directly from the drone, allowing officials to do the following: Communicate with the pilot through a backchannel connection. Instruct the operator to land. Obtain operator information and current drone location information. See all drones in the area in real time on a map. No internet connection is needed. The backchannel is a wireless communications technology for reception or transmission that is typically, but is not required to be, a different wireless communications technology than is in primary use. For example, where WiFi is the typical communication, Bluetooth communication is a good choice for the backchannel.

The apparatus of the present invention is an all-in-one, self-contained drone tracking solution. In as little as 60 seconds, the device can be connected and sending information to the cloud.

The apparatus of the present invention addresses spoofing by determining the range (e.g. distance and direction vector) between a drone and the operator of said drone and enabling a comparison algorithm to determine if there is spoofing.

The software systems of the present invention are enabled to collect and offer users crash management operations to enable predetermined functions or procedures to be followed, to enable communications pinging on available communications/radio/WiFi channels, and to trigger or remotely enable onboard forensics already present.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A Digital License Tag electronic apparatus for providing a digital identity and geospatial telemetry broadcast data for an unmanned vehicle comprising a local memory identity storage, a cellular transmission device, a wireless network transmission device, a Bluetooth transmission device, a global position telemetry device, and a power source enabling storage of a unique digital identity and the broadcast of said unique digital identity and a current position geospatial telemetry and identity dataset bread crumb for said unmanned vehicle.

2. The apparatus of claim 1, further comprising a light emitting device having a beacon enabling visual recognition of said unmanned vehicle.

3. The apparatus of claim 1, further comprising a set of sensors comprising not less than, a received cellular signal strength sensor, a temperature sensor, a light strength (day or night indicator) sensor, a flip sensor (crash detector), an air pressure (pressure altitude) sensor and air quality index.

4. The apparatus of claim 1, further comprising internet enabled software application enabled to store said current position telemetry and identity dataset bread crumb for said unmanned vehicle when broadcasted by said electronic device in a datastore.

5. The apparatus of claim 1, further comprising internet enabled software application enabled to store and authenticate said current position telemetry and identity dataset bread crumb for said unmanned vehicle when broadcasted by said electronic device in a datastore.

6. The apparatus of claim 1, further comprising internet enabled software application enabled to store and transmit said current position telemetry and identity dataset bread crumb for said unmanned vehicle when broadcasted by said electronic device in a datastore.

7. The apparatus of claim 1, further comprising internet enabled software application enabled to store, authenticate, and transmit said current position telemetry and identity dataset bread crumb for said unmanned vehicle when broadcasted by said electronic device in a datastore.

8. The apparatus of claim 1, further comprising internet enabled software application enabled to store, authenticate, and transmit said current position telemetry and identity dataset bread crumb for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle.

9. The apparatus of claim 1, further comprising internet enabled software application enabled to store, authenticate, and transmit said current position telemetry and identity dataset bread crumbs for said unmanned vehicle when broadcasted by said electronic device in a datastore wherein said datastore is connectively attached to and enables the creation and electronic storage of a data block in said datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

10. A Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, and a power source enabling a unique digital identity and the acquisition and broadcast of a current position telemetry and identity dataset bread crumb for said unmanned vehicle and an internet enabled computer software application based system having a datastore to store and verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle.

11. The apparatus of claim 10, further comprising a set of sensors comprising not less than, a received cellular signal strength sensor, a temperature sensor, a light strength (day or night indicator) sensor, a flip sensor (crash detector), an air pressure (pressure altitude) sensor and air quality index.

12. The apparatus of claim 10, wherein the internet enabled software application is further enables a creation and an electronic storage of a data block in the datastore wherein said data blocks comprise said current position telemetry and identity dataset bread crumb data for said unmanned vehicle as broadcast by said electronic device during operation of said unmanned vehicle.

13. The apparatus of claim 10, wherein the internet enabled software application is further enables a creation and an electronic storage of a data block in the datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.

14. A Digital License Tag electronic device for providing a digital identity and geospatial telemetry broadcast data for an unmanned vehicle comprising a local memory identity storage, a cellular transmission device, a wireless network transmission device, a bluetooth transmission device, a global position telemetry device, a light emitting device having a beacon enabling visual recognition of said unmanned vehicle, and a power source enabling a unique digital identity and the acquisition and broadcast of a current position telemetry and identity dataset bread crumb for said unmanned vehicle and a computer software based system having a datastore to verify a unique identity for said electronic device, and programmed to enable a wireless tracking system for unmanned vehicles enabled to receive, store, and transmit a plurality of bread crumb transmissions broadcasted by said electronic device during the operation of said unmanned vehicle.

15. The apparatus of claim 14, further comprising a set of sensors comprising not less than, a received cellular signal strength sensor, a temperature sensor, a light strength (day or night indicator) sensor, a flip sensor (crash detector), an air pressure (pressure altitude) sensor and air quality index.

16. The apparatus of claim 14, wherein the internet enabled software application is further enables a creation and an electronic storage of a data block in the datastore wherein said data blocks comprise said current position telemetry and identity dataset bread crumb data for said unmanned vehicle as broadcast by said electronic device during operation of said unmanned vehicle.

17. The apparatus of claim 14, wherein the internet enabled software application is further enables a creation and an electronic storage of a data block in the datastore wherein said data blocks comprise said current position telemetry and identity dataset bread crumb data for said unmanned vehicle as broadcast by said electronic device during operation of said unmanned vehicle thereby enabling a block chaining of a plurality of said data blocks.
